(19) United States
(12) Patent Application Publication
(10) Pub. No.: US 2016/0270594 A1
(43) Pub. Date: Sep. 22, 2016

(54) DEVICE FOR COOKING FOOD ARTICLES

(71) Applicant: Johann VERHEEM, Encinitas, CA (US)

(72) Inventor: Johann VERHEEM, Encinitas, CA (US)

(21) Appl. No.: 15/072,224

(22) Filed: Mar. 16, 2016

Related U.S. Application Data
(60) Provisional application No. 62/133,890, filed on Mar. 16, 2015.
(60) Provisional application No. 62/165,757, filed on May 22, 2015.
(60) Provisional application No. 62/239,891, filed on Oct. 10, 2015.

(51) Int. Cl. A47J 37/10

(52) U.S. Cl. CPC A47J 37/101; A23L 1/31; A23V 2002/00

(57) ABSTRACT

A device for cooking one or more food articles is provided, the device using a hard lid placed directly on top of the food article. The lid applies pressure on the one or more food articles and a cooking surface beneath the one or more food article through mechanical means.

### CROSS-REFERENCE TO RELATED APPLICATIONS

This application claims priority to and benefit under 35 U.S.C §119(e) of U.S. Provisional Patent Application Ser. No. 62/133,890 filed Mar. 16, 2015, U.S. Provisional Patent Application Ser. No. 62/165,757 filed May 22, 2015, and U.S. Provisional Patent Application Ser. No. 62/239,891 filed Oct. 10, 2015, the contents of which are incorporated herein by reference in their entirety as if set forth verbatim.

### FIELD

The following description relates generally to a device that is used to prepare cook food in an oven or microwave such as bacon in an oven or microwave and specifically, for devices that to shape bacon strips into specific forms for cooking.

### BACKGROUND

For years, food articles have been cooked prior to serving or enjoying meals. Food articles in this respect can be cooked meats such as bacon which has been a very popular food in recent times as part of meals or snacks throughout the day. With respect to bacon specifically, it can be cooked many ways including being fried in a pan, baked in an oven or cooked in a microwave as part of breakfast, as part of sandwiches and/or in combination with other foods such as meat, fish, poultry or vegetables.

Food articles such as bacon can typically be cut into thin strips and have a high fat content. There are numerous challenges preparing bacon specifically. These challenges include reducing or controlling the fat that becomes liquefied when bacon is heated up. Because bacon typically includes thin, elongated strips or pieces, cooking a strip of bacon evenly is also complex, with some portions of a single strip often being overcooked while others remaining raw. In addition, bacon also shrinks in volume while being cooked and as a result can deform and curl up, further increasing the changes of uneven cooking. In addition, bacon is cut in slices that can be 14 inches or longer and as a result often not fit comfortably inside standard size microwave turntables.

Numerous devices have attempted to address these challenges. Some devices suspend the bacon in the air using a rack type design, in order to allow for fat to run off. However, these approaches require a cumbersome process of placing the bacon in individual elevated slots and fail to address the shrinkage problems associated with the strips. Some devices also hang bacon over an edge of a porcelain cup to reduce length and drain fat. Therefore, a need exists to resolve these and other problems in the art.

### SUMMARY

The following simplified summary is provided in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

A device for cooking one or more food articles is disclosed that uses a lid placed directly on top of the food article. The lid may be substantially rigid. The lid may apply pressure on the one or more food articles and a cooking surface beneath the one or more food article through mechanical means. The cooking surface may be relatively flexible or substantially rigid. In certain embodiments, the base may be disposed underneath the lid and the one or more food articles, the base being made from a softer material. The base may also be operable to bend and attach to the lid.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 is an upper perspective view of the herein disclosed cooking device in an assembled state.

FIG. 2 is an upper perspective view of the cooking device of FIG. 1. wherein the lid and corresponding handle surface are raised from the associated cooking surface.

FIG. 3 is an upper perspective view of the cooking device of FIG. 1 in an exploded state.

FIG. 4 is an upper perspective view of the cooking surface of the cooking device of FIG. 1.

FIG. 5 is an upper perspective view of a base device of the cooking device of FIG. 1.

FIG. 6. is a side cross section view of the cooking device of FIG. 1 depicting the interconnections of certain features of the cooking device.

FIG. 7. is a side cross section view of the cooking device of FIG. 1 depicting the interconnections of certain features of the cooking device with an optional adjustment mechanism.

FIG. 8 is an upper perspective of another embodiment of the herein disclosed cooking device in an exploded state.

FIG. 9 is an upper perspective of the disclosed cooking device of FIG. 8 in an assembled state.

FIG. 10 is a lower perspective of the disclosed cooking device of FIG. 8 in an assembled state.

FIG. 11 is an upper perspective view of a base device of the cooking device of FIG. 8.

FIG. 12 is a similar view of FIG. 11, wherein the base device has been rotated to further depict the inclination angle of certain retaining grooves and exemplary depth and position of the receptacle surface.

FIG. 13 is a top plan view of the base device of FIG. 11.

FIG. 14A is an upper perspective view of an exemplary cooking device, wherein the handle surface positioned on the adjustment mechanism is in a first position.

FIG. 14B is an upper perspective view similar to FIG. 14A, wherein the handle surface has been rotated to a second position from the first position.

FIG. 15 depicts a close-up perspective view of another exemplary adjustment mechanism disposed in communication a handle surface in a first position.

FIG. 16A depicts a close-up cross section view of the embodiment of FIG. 15, wherein the handle surface and associated adjustment mechanism are in the first position of FIG. 15.

FIG. 16B is similar to FIG. 16A, wherein the handle surface has moved to a second position causing the resistance element to adjustably depress.

FIG. 16C is similar to FIG. 16B, wherein the handle surface has moved to a third position causing the resistance element to adjustably depress.

FIG. 16D is similar to FIG. 16C, wherein the handle surface has moved to a fourth position causing the resistance element to adjustably depress yet further.

FIG. 17A is an upper perspective of another embodiment of the herein disclosed cooking device in an exploded state.

FIG. 17B is an upper perspective of the disclosed cooking device of FIG. 17A in an assembled state.

FIG. 18 depicts an upper perspective view of an exemplary tray insert.

FIG. 19 depicts a lower perspective view of the insert of FIG. 18.

FIG. 20 depicts a cross-sectional view of section A-A of FIG. 18.

FIG. 21 depicts a side plan view of the cooking device of FIG. 18.

FIG. 22 depicts an upper perspective view of another exemplary tray insert.

FIG. 23 depicts a lower perspective view of the insert of FIG. 22.

### DETAILED DESCRIPTION

The features of the presently disclosed solution may be economically molded or assembled by using one or more distinct parts and associated components which, may be assembled together for removable or integral application. Unless defined otherwise, all terms of art, notations and other scientific terms or terminology used herein have the same meaning as is commonly understood by one of ordinary skill in the art to which this disclosure belongs.

In some cases, terms with commonly understood meanings are defined herein for clarity and/or for ready reference, and the inclusion of such definitions herein should not necessarily be construed to represent a substantial difference over what is generally understood in the art. All patents, applications, published applications and other publications referred to herein are incorporated by reference in their entirety. If a definition set forth in this section is contrary to or otherwise inconsistent with a definition set forth in the patents, application, published applications and other publications that are herein incorporated by reference, the definition set forth in this section prevails over the definition that is incorporated herein by reference.

As used herein, “a” or “an” means “at least one” or “one or more.” As used herein, the term “user”, “subject”, “end-user” or the like is not limited to a specific entity or person. For example, the term “user” may refer to a person who uses the systems and methods described herein, and frequently may be a technician. However, this term is not limited to end users or technicians and thus encompasses a variety of persons or entities who can use the disclosed systems and methods.

As used herein, the term “food article” is used herein with reference to any type of food that can be cooked, for example, in an oven, on a grill, in a pan, or the like. Such food articles may include meat such as pork, beef, lamb, poultry, fish, crustaceans, or the like. Specifically, this can include such foods in processed form such as strips (e.g. bacon), links, patties, or any other consumable form. Food articles may also include any other consumable including vegetables, raw or in processed form such as soy-based tempheh, tofu or the like. Any food article described herein is not intended to be limited to that particular form unless specifically noted, but rather is merely for purposes of particularity and ease of reference.

As used herein, the term “heating supply” is used herein with reference to any type of source of heat including an oven, a microwave, or the like.

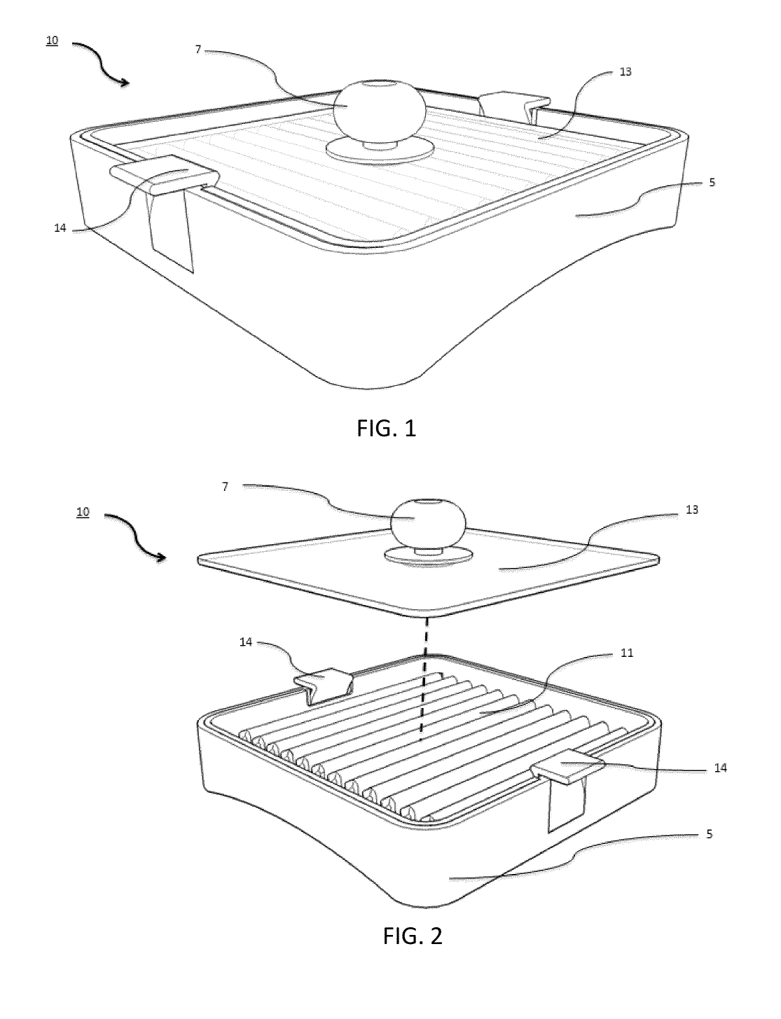

The disclosed solution can now be better understood turning to the following detailed description. It is to be expressly understood that the illustrated embodiments are set forth as examples and not by way of limitations on the embodiments as ultimately defined in the claims. Specifically, FIGS. 1-21 show various exemplary embodiments and features of the herein described cooking devices.

In one aspect of the disclosed embodiments, a cooking device 10 may include a base 5 and one or more handling surfaces 7. The handling surface 7 may be formed by one or more rods, sticks, forks or cylindrical tubes. Surface 7 may be designed to interact with device 10 by retaining the same and place, facilitating radiation and conductive heat transfer to the food article housed in device 10 while also being detachably fastened with base 5.

Surface 7 may be designed to manipulate the food article by, for example, wrapping the food article or applying pressure to the food article when the food article is bacon. In this respect, surface 7 and lid 13 may function together with food receiving area 11 to manipulate the food article into a predetermined shape and securing the same in a suspended and/or elevated position above base 5. In this embodiment, this arrangement permits device 10 to capture the fat resulting from cooking the food article when device 10 and corresponding food article is disposed in a microwave, oven, or other cooking environment.

Surface 7 may be placed, positioned, securely engaged with, or otherwise operatively connected to lid 13 as well as food receiving areas 11 of base 5 when lid 13, surface 7, and base 5 are in an assembled state as in FIG. 1. Lid 13 may be in a transparent state so that food receiving area 11 and corresponding features are visible though the design is not so limited. Lid 13 in fact may take any form or shape depending on need or preference. In some embodiments, lid 13 may be transparent so that the food article disposed therein is externally viewable to monitor cooking status. Optionally, an externally visible temperature, timer, or optional cooking status gauge may be visible to an end user to indicate status of the food article. Food receiving area 11 may be removably or integrally formed with base 5 and operable to receive surface 7 and associated lid 13.

Food receiving area 11 may be constructed from one or more sticks, rods, forks or tubes in a predetermined pattern. In certain embodiments, the sticks, rods, forks or tubes are arranged in a vertical, angled or horizontal direction. Preferably, surface 7 will maintain areas 11 in a secured position as well as any food article disposed therebetween. This particular arrangement is advantageous as it permits for multiple food articles, such as bacon, to be wrapped around, penetrated or placed on a stick, rod, fork or tube of areas 11 to be placed on base 5 at the same time.

When the food article is bacon and is suspended inside device 10 between lid 13 and surface 11, fat and liquid generated by cooking the food article will be running off into a chamber of base 5 and easily discarded at a later time. As stated, food receiving area 11 may be integrated or detachable with base 5 and operable to receive one or more food articles. Base 5 can contain characteristics that will allow for fat produced by the cooking or backing process to separate from the food article. These characteristics can include one or more angled or otherwise slanted surfaces where the fats and liquids produced by the process will run off to one side of food receiving area 11.

As seen in FIG. 4, food receiving area 11 may include perimetral walls with an internally positioned recess and associated collector underneath, adjacent to, or otherwise operable to communicate with grooves or patterns 17. In turn, grooves or patterns 17 may be integrally formed with or detachable from food receiving area 11 and be designed to elevate the food article higher in certain predetermined areas so that fat can travel into grooves 17 away from the food article. In addition, optional grooves may be provided that are angled or slanted and positioned at the top, bottom or at the top and the bottom of food receiving area 11 so that fat and liquids travel away from the food article and towards one or more collectors or receptacles of food receiving area 11.

Turning back to FIG. 2, lid 13 of device 10 can be detached therefrom to open base 5 and permit an article of food to be deposited or removed from food receiving area 11 and/or base 5. Lid 13 may be detachable, either completely or may remain pivotally connected to an edge or portion of base 5 or food receiving area 11. When lid 13 is detached, completely or otherwise, food articles such as bacon strips may be placed in between lid 13 and surface 11. Lid 13 can include a mechanism for pressing the food article firmly or with predetermined pressure applied uniformly or in one or more predetermined locations against surface 11 of base 5. The pressure distributed on the food article from lid 13 can come from weight of lid 13 or it can come from a variety of different mechanisms and/or applied loads that can create downwards pressure on the lid 13.

As stated previously, lid 13 may be solid, transparent, or translucent so that the user can externally monitor the degree to which the food article is being cooked. Preferably, a glass lid 13 that is both transparent and heat resistant is used with device 10. In addition, lid 13 prevents fat and liquids from the cooking process from splattering in the oven or microwave and it traps the heat between the cooking surface 11 and lid 13, creating increased heat around the food article compared to an open tray or container, thereby decreasing cooking time.

As can be seen, surface 7 may be a handle or a knob removably attached to or integrally formed with lid 13 to make removal of lid 13 from base 5 and/or surface 11 easy. In the case of lid 13 being hingedly connected to base 5 and/or surface 11, various different areas for picking up lid 13 can be used. To provide optimal pressure between the cooking surface 11 and lid 13 pressing on the food article in a similar fashion as a traditional cast iron bacon press, various tightening mechanisms can also be utilized.

As seen throughout the figures, one or more clamps 14 with a slanted edge can be utilized to put downwards pressure on lid 13. Because the inside of the clamps are slanted inwards towards the cooking surface 11, clamps 14 will maintain downwards pressure on lid 13 towards the cooking surface 11 and will thereby put pressure on the food article. This design allows for sufficient pressure to be applied regardless of how thick the food article is and whether a single or multiple layers of food articles (e.g. multiple bacon strips) is placed between the lid 13 and the cooking surface 11.

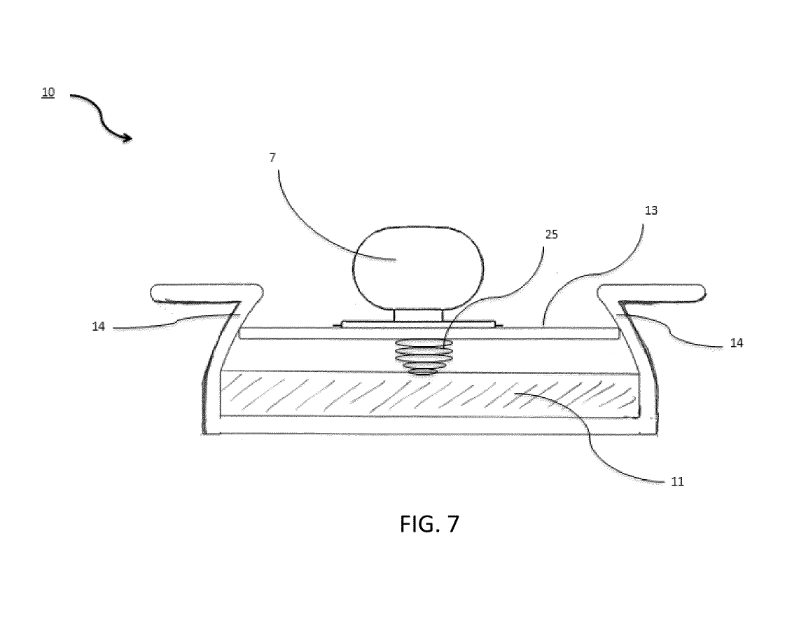

Alternatively, as seen in FIG. 7, an adjustment mechanism 25, can be used to both create and adjust pressure applied to cooking surface 11 from lid 13. Preferably, mechanism 25 adjusts and/or delivers pressure by having a rotating knob 7 or other handle in lid 13 with a protruding locking mechanism or screwing mechanism that will attach to or screw into the cooking surface 11 until a desired level of pressure is reached. Alternative screwing or latching mechanisms can be placed on one or more sides of the lid to ensure the lid closes tightly on the bacon and cooking surface.

The base 5 of the device 10 can be fully integrated and include of one piece of material and can be molded as such. In this embodiment as shown in FIG. 2, the edge of the base 5, the flexible clamps 14 on the side of the base 5 and the cooking surface 11 can be made or manufactured from a single semi-rigid, soft or rigid material. Some level of flexibility is desirable in all or one of these features to allow the side clamps 14 to be bendable though the design is not so limited.

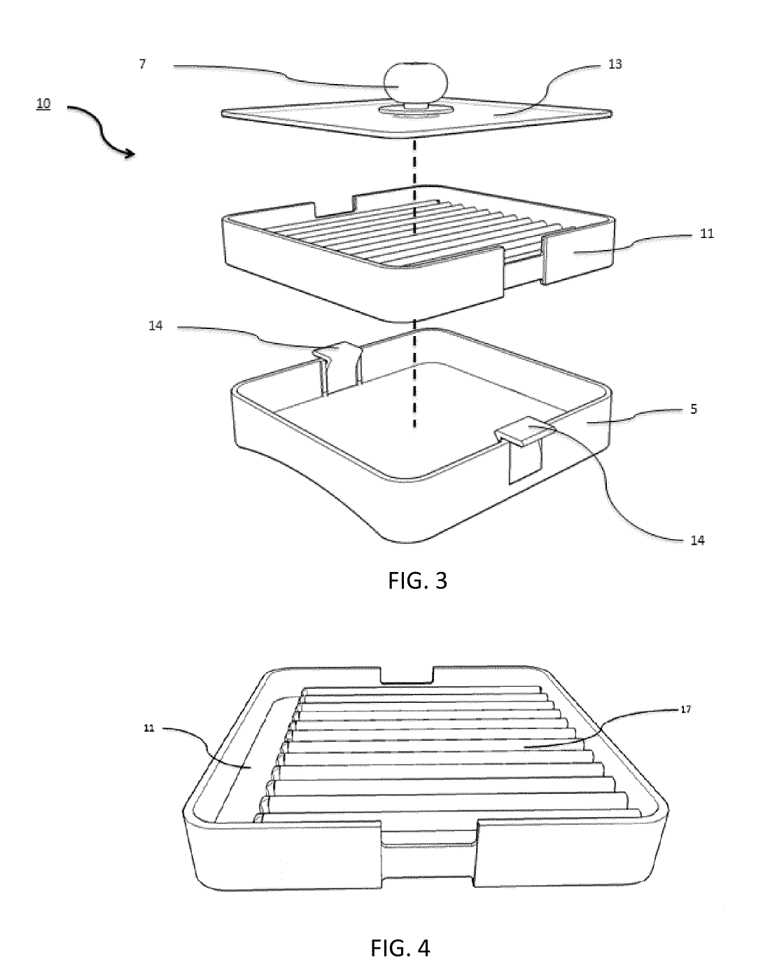

In another embodiment of the device 10, some of the components can be manufactured separately and from different materials. FIG. 3 demonstrates an embodiment where the cooking surface 11 may be modular and made from one or more different materials, than the base 5 or side clamps 14. This allows for making the cooking surface 11 removable and/or rotatable so that different sides of the cooking surface 11 can be used with different patterns or functionality. The reverse side of the cooking surface 11 could optionally be smooth for use with food articles such as tortillas or pancakes.

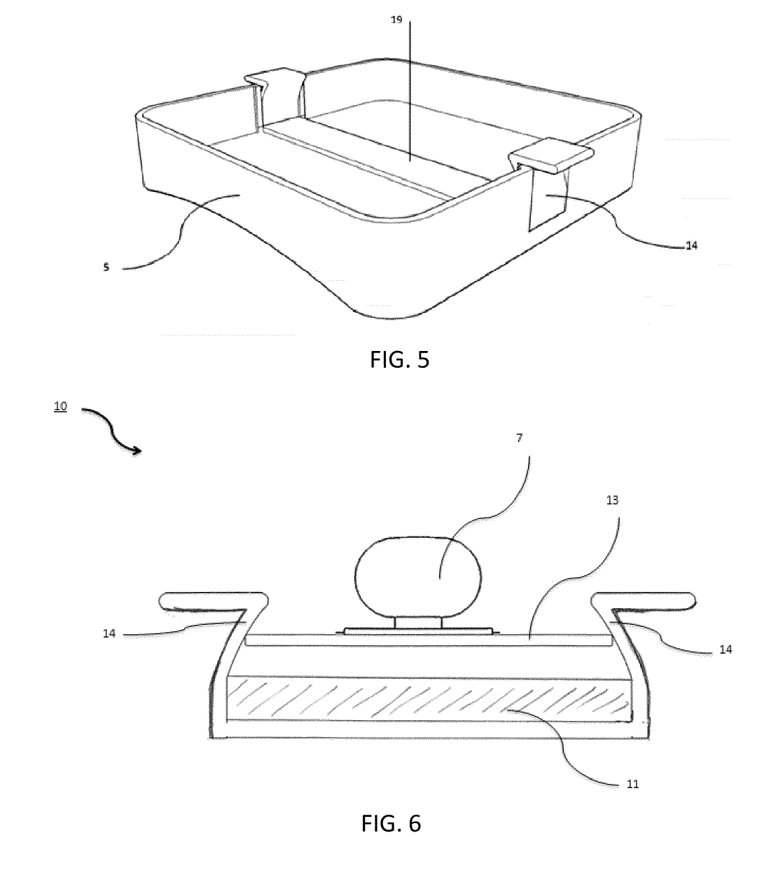

The side clamps 14 can be attached to each other with base 5 operable to receive surface 11 with cross bar 19 as demonstrated in FIG. 5. The crossbar 19 is made from a flexible material, which allows the side clamps 14 to be pushed to the outside and retract inwards to push down on the lid 13 in the locked position as depicted in FIG. 5. This eliminates the need for movable parts or hinges to facilitate pressure from the clamps 14. The degree of flexibility required to bend the clamps 14 outwards and maintain inwards pressure comes from flex in both the clamps 14 and the crossbar 19.

The crossbar 19 can also be integrally formed or detachable with the cooking surface 11, by attaching the crossbar 19 at the bottom of the cooking surface 11 or by molding the cooking surface 11 from a heat resistant but flexible material such as silicone over the crossbar 19. In addition, the entire cooking surface 11 could be made from flexible heat resistant material such as silicone and molded over the crossbar 19 and the crossbar 19 and the side clamps 14 so that the crossbar 19 is completely embedded in the cooking surface 11 and entirely covered in silicone or other flexible heat resistant material. In this embodiment the entire device 10 includes of the base 5 with integrated cross bar 19 and the lid 13 with handle surface 7. There will be no separate base 5 and cooking surface 11.

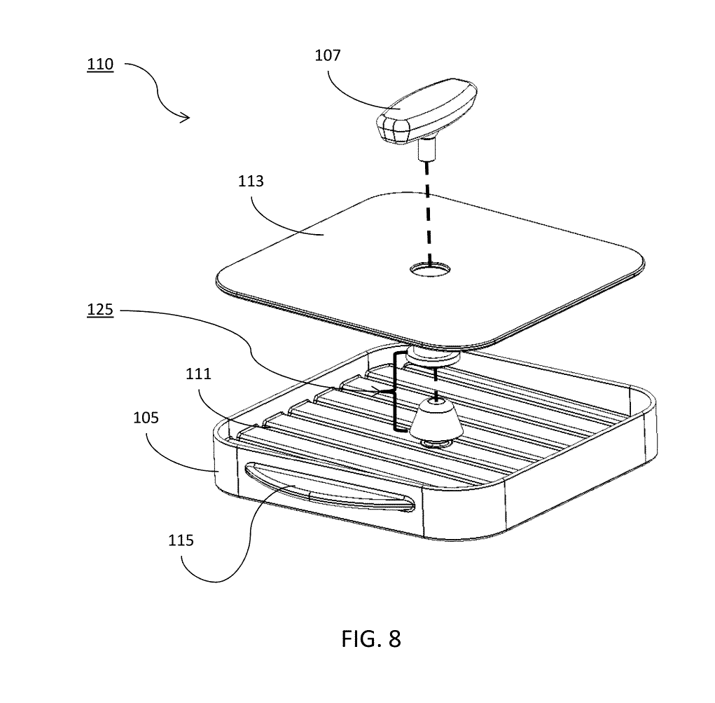

Turning to FIG. 8, an upper perspective of another embodiment of a cooking device 110 is depicted in an exploded state. It is to be understood that features with similar numbers may be similar or the same as those previously described in FIGS. 1-7. In this respect, device 110 may include base 105 with handling surface 107. Surface 107 may be designed to interact with device 110 and its corresponding lid 111 by retaining the same and place, facilitate radiation of heat and conductive heat transfer to the food article housed or being heated by device 110 while also being detachably fastened with base 105.

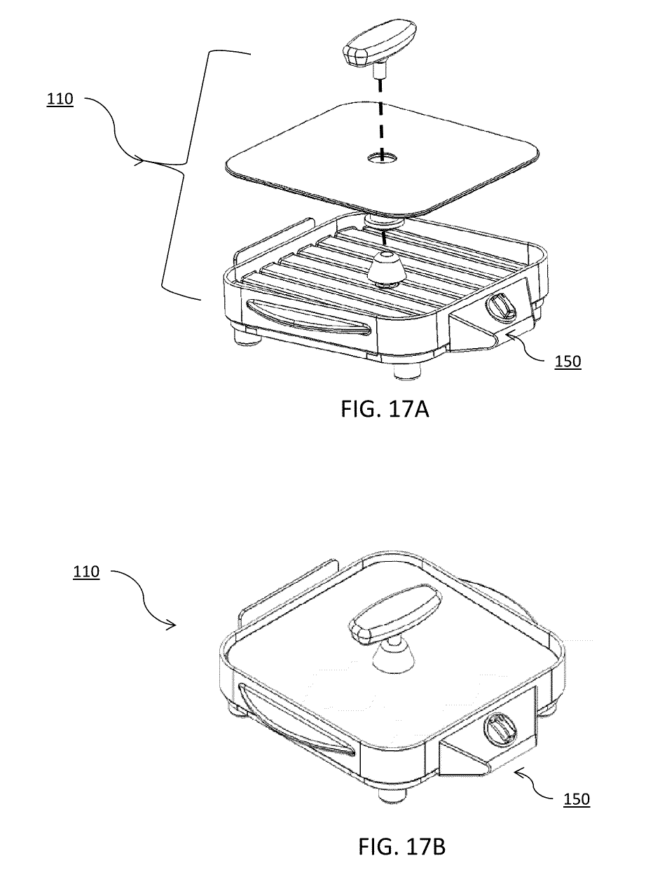

Device 110 may be operable to be positioned in an oven or microwave and therefore all of its constituent parts are operable to be placed in environments in excess of 500° F. or be positioned in a microwave during use. Optionally, device 110 may be operable to receive power from an external power supply such as seen in FIGS. 17A and 17B. In this embodiment, device 110 may include a heating element integrally formed therewith or detachably connected thereto operably to be in electrical communication with the external power supply and apply heat from the heating element to the food article internal to device 110.

Turning back to FIG. 8, surface 107 may be designed to manipulate the food article by, for example, wrapping the food article when it is bacon into a predetermined shape and securing the same in a suspended and/or elevated position above base 5. In this embodiment, this arrangement permits device 10 to capture the fat resulting from cooking the food article when device 10 and corresponding food article is disposed in a microwave, oven, or other cooking environment.

Whether in use with a microwave, an oven, or another external power supply, lid 113 may be operable to detachably connect with base 105 and form a seal therewith. In this respect, any food article disposed between base 105 and lid 113 can be uniformly and evenly cooked since pressure and head is distributed evenly. Optionally, lid 113 may include one or more vents so that fluids and pressure may be egress and avoid reaching a predetermined level of pressure inside device 110 during use. In this respect, fluids and other particulate related to the food article being cooked by device 110 during use are caused to be trapped between base 105 and lid 113 and preferably between areas 111 and lid 113. One or more venting areas may also be included adjacent to the region where adjustment mechanism 125 and surface 107 and lid 113 and/or venting areas may be positioned about one or more perimetral edges in communication with base 105.

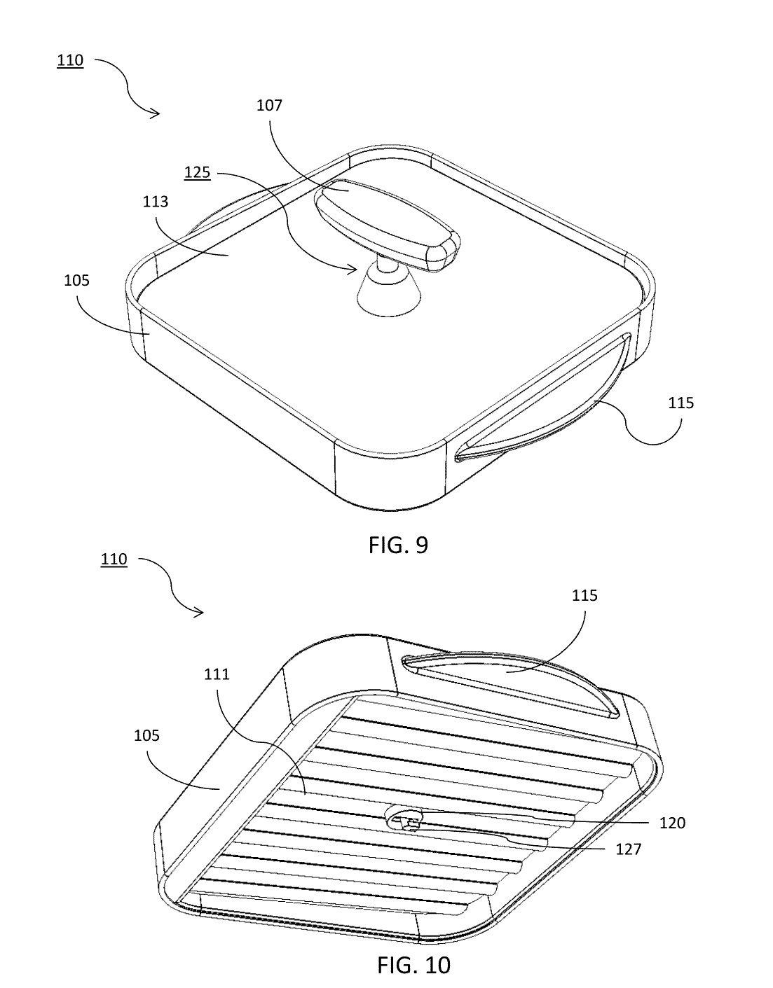

FIG. 9 more clearly depicts device 110 in an assembled state so that lid 113 and its associated relationship with base 105 can be further seen. It can also be seen that device 110 further includes one or more peripheral handles 115. Turning to FIG. 10 is a lower perspective of device 110 in an assembled state. Specifically, a lower retaining member 127 of mechanism 125 can be seen in communication with receiver 120 of base 105. Member 127 is operably to be detachably inserted through an opening in receiver 120 and be movable between two or more positions and/or orientations. In this respect, member 127 can be seen terminating in an outwardly extending locking surface operable to contact a lower receiving surface of receiver 120 and prevent mechanism 125 from being pulled vertically.

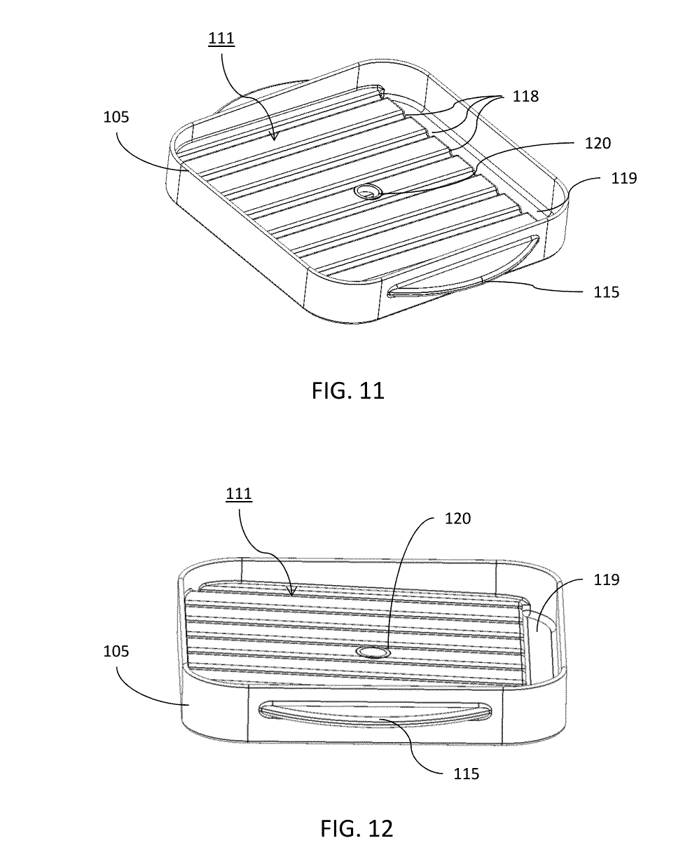

Turning to FIG. 11, base 105 can be more clearly seen along with the upper receiving surface of receiver 120. Additionally, exemplary food receiving channels 118 can also be seen terminating in particulate receptacle 119 as described more particularly below. Specifically, as seen in FIG. 12, areas 111 may include the one or more channels 118 with a predetermined declining angle with respect to base 105. Accordingly, as the food article is positioned on area 111 and in communication with respective channels 118 (e.g. a piece of bacon rolled up and detachably received by associated channels 118), lid 113 may be situated thereon to trap and apply heat uniformly to the food article. In this process, as fats or other byproducts are caused to be emitted from the food article, they are capable of being drained into receptacle 119. Receptacle 119 in turn may be operable to receive oils, fats and other cooking food byproducts at substantially elevated temperatures.

This is particularly advantageous since receptacle 119 may be integrally formed with base 105 and area 111. In an exemplary embodiment, base 105 with integrally formed receptacle 119 and channels 118 of area 111 oriented at a predetermined declining angle may be constructed from a material capable of being removed from device 110 and washed in a conventional sink or dishwasher. Device 110 in this respect is particularly advantageous since it is easy to clean for more than one use. However, device 110 is not so limited and any number of its foregoing features may be detachable or integrally formed together as needed or required. While only one angle is depicted, any number of declining angles may be used and an angle adjustment mechanism may also be included so that the end user can control the declining angle of area 111 for use with a particular food article or according to a particular recipe or cooking style.

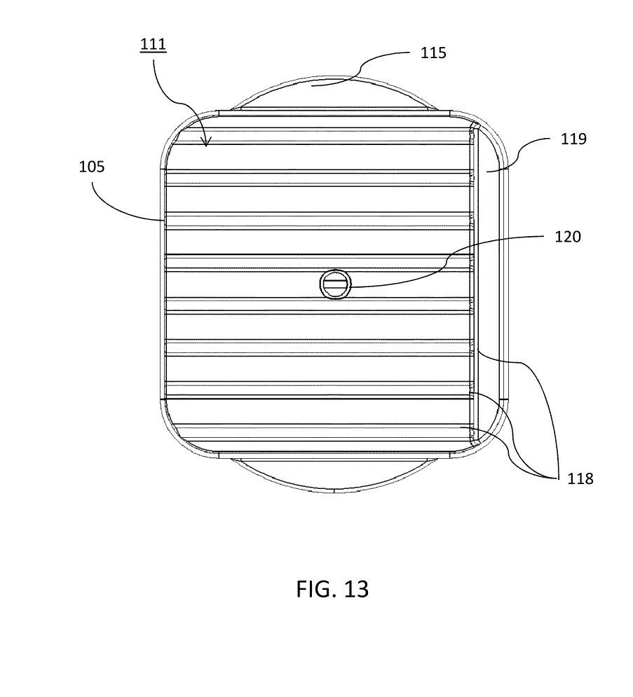

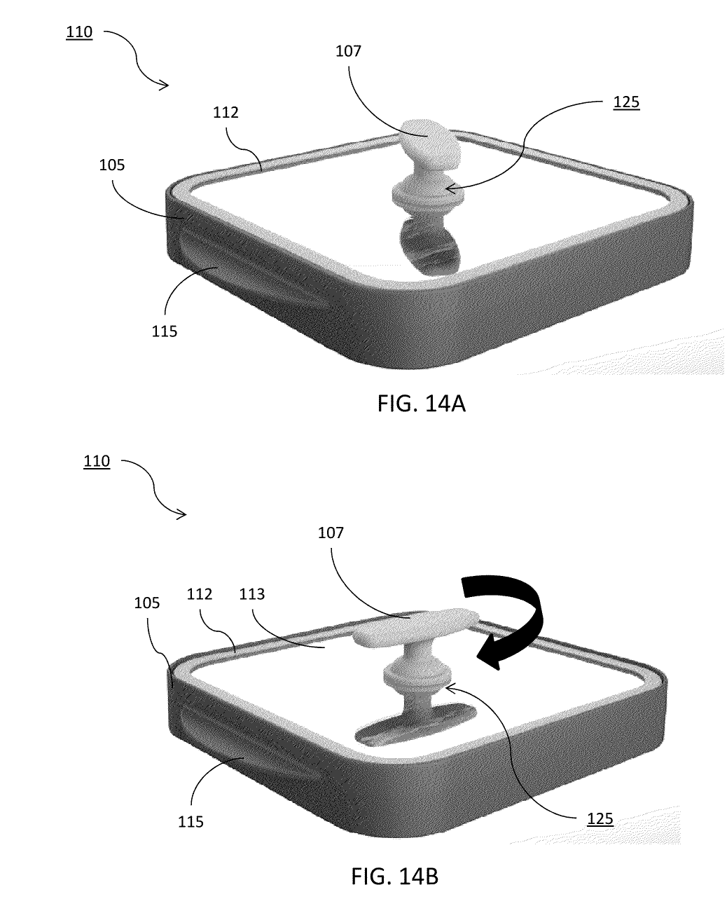

With respect to adjustment mechanism 125 of device 110, FIG. 14A depicts an upper perspective view of device 110 with surface 107 positioned in communication with mechanism 125 in a first position. It can be seen that lid 113 in this embodiment may include peripheral edge seal 112 disposed about and in communication with base 105 and lid 113. In contrast, FIG. 14B depicts surface 107 having been rotated to cause mechanism 125 adjust the respective distance between lid 113 and area 111 as described more particularly below.

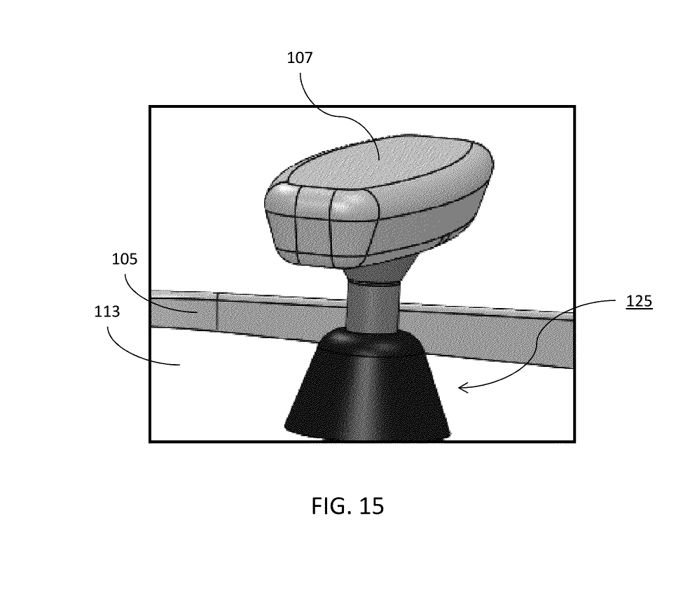

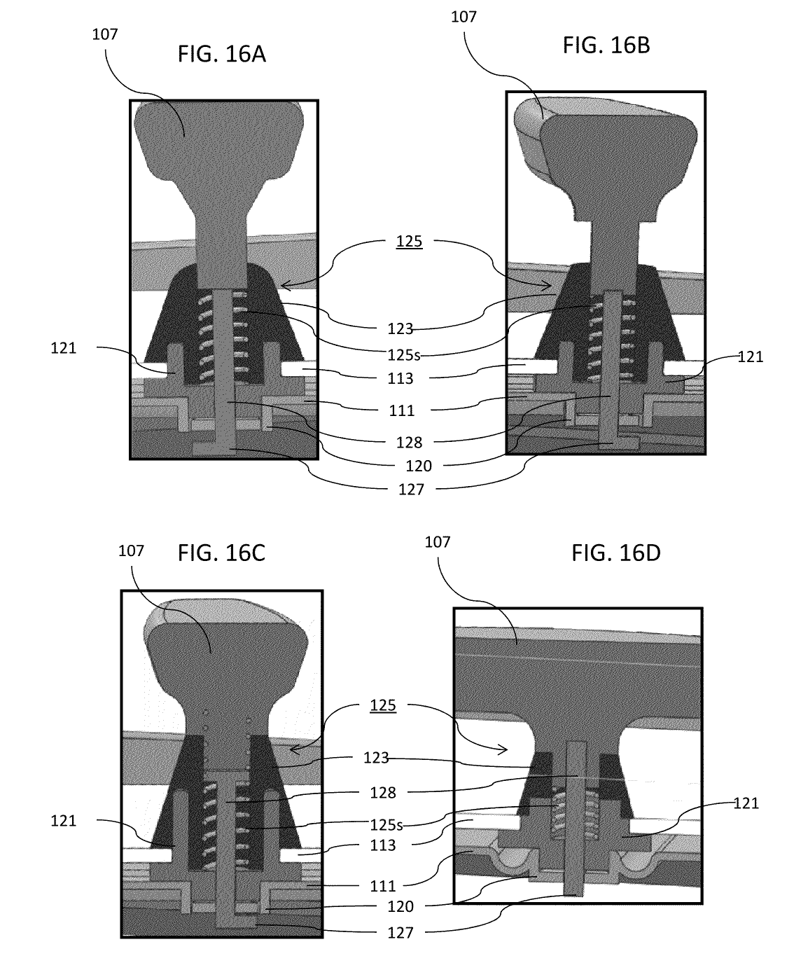

FIG. 15 depicts a close-up perspective of exemplary adjustment mechanism 125 disposed in communication surface 107, lid 113, and base 105, wherein handle 107 is in a first position. FIG. 16A depicts a close up of a cross section view of mechanism 125 and device 110 of FIG. 15 in a preferred embodiment. Preferably, surface 107 can be seen depicted in communication with an elongate member 128 operably to extend from surface 107 through lid 113 and below area 111. Disposed on distal portion of member 128 is previously described member 127. Moving between the first position of FIG. 16A and the second position FIG. 16B, it can be seen that movement of surface 107 causes member 127 to also pivot about a longitudinal axis of member 128. Member 128 may be mechanically attached to a lower portion of surface 107 and a resistance element 123 may be positioned between the lower portion of surface 107 and a washer 121 mechanically attached between lid 113 and area 111.

As can be seen in moving between FIGS. 16A through 16D, as surface 107 rotates about the longitudinal axis of member 128, surface 107 may translate towards area 111 thereby increasing the distributed applied load from lid 113 to the food article positioned between lid 113 and area 111. As can also be seen, element 123 may provide adjustably resistance at increasing depths ranging between greatest resistance in FIG. 16D and least resistance in FIG. 16A. Washer 121 may be substantially rigid or be partially resilient to flexibly seal with receiver 120 as increasing loads are applied with decreasing depths between FIGS. 16A and 16D.

This is particularly advantageous as it allows the end user to load device 110 with food articles and then crank or rotate surface 107 between two or more predetermined positions to adjustably seal the food article between lid 113 and area 111 until the desired position is obtained. Particularly, in the embodiments of FIGS. 16A through 16D, element 123 adjustably controls the range of motion that lid 113 may travel with respect to area 11 and the predetermined cooking height defined between lid 113 and area 111 may not be exceeded as presently depicted. This is also advantageous as device 110 as depicted promotes uniform transfer of heat to the food article since heat may be radiated and conductively transferred across all surfaces of device 110 and device 110 is now uniformly applying pressure across the lower and upper surfaces of the food article.

While element 123 may preferably be a coil spring as depicted, mechanism 125 is not so limited and element 123 may instead be any bias element, coil, elastic member, helical compression member, leaf, and/or torsional. Alternatively, moving between positions of FIGS. 16A through 16D may be caused by moving between corresponding notches or locking members positioned with washer 121, receiver 120 and/or any other receiver mechanically attached to lid 113 and area 111.

FIG. 17A depicts another embodiment of device 110, wherein device 110 in this embodiment is in an exploded state and operable to electrically connect with an external power supply. Accordingly, a heating element may be included in this embodiment operably to regulated by heat adjustment mechanism 150. Preferably, mechanism 150 may be a dial or knob that can be rotated between two or more heating positions ranging from coldest to hottest cooking temperatures. FIG. 17B simply depicts an assembled device 110 and mechanism 150. As can also be seen, device 110 may have one or more pedestals disposed underneath device 110 to provided added support and stability for device 110 during use.

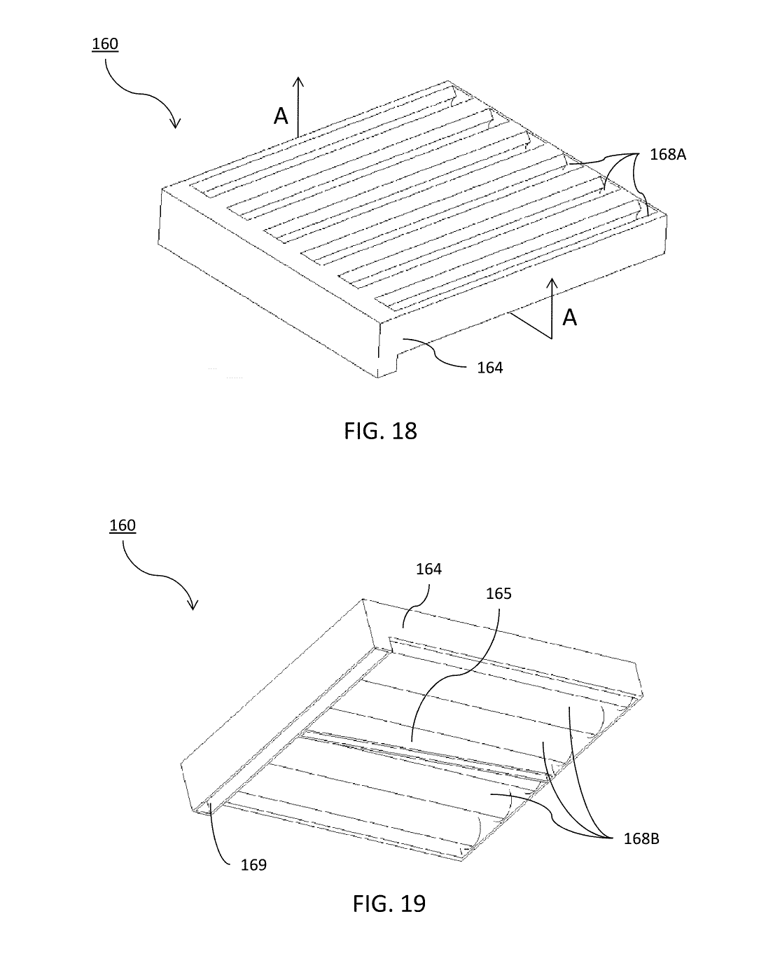

In another embodiment, a tray insert 160 of FIG. 18 may be provided for use with device 110. FIG. 18 specifically depicts an upper perspective view of insert 160 whereas FIG. 19 depicts a lower perspective view. Device 110 may be used with lid 113 and insert 160 or insert 160 only and therefore without lid 113. Insert 160 may be constructed from rigid or resilient materials. In a preferred embodiment, insert 160 may be molded from relatively resilient materials such as silicone or other plastics operable to function in an oven, microwave, or be used with heating element associated with mechanism 150. In this respect, insert 160 may be operable to conformably attach or otherwise communicate with base 105 during use.

Similar to channels 118, insert 160 may include one or more food article receiving channels 168 disposed between peripheral edge 164. Insert 160 may also have one or more particulate receptacle portions 169 with an opening operably to communicate with corresponding receptacle 119. In this respect, the end user may removably insert the food article in a respective channel 168A for use with device 110. As the food article is being cooked, the previously describe byproducts may then collect in channel 168A until egressing through portion 169.

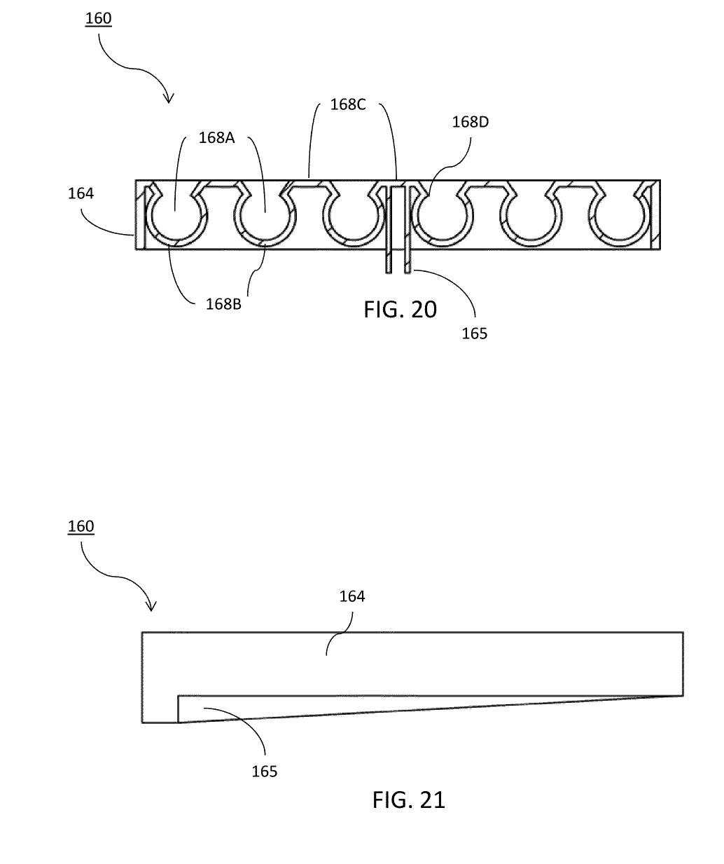

As can be seen in FIG. 19, novel central support member 165 may be provided and include a declining angle to further facilitate byproducts to flow towards portion 169. Turning to FIG. 20, insert 160 is depicted in a cross-sectional view of section A-A of FIG. 18. FIG. 21 depicts a side plan view of the cooking device of FIG. 18. Specifically, in FIG. 20 it can be seen that each channel 168 can be seen with receiving area 168 defined by groove 168B and terminating in one or more inwardly extending retaining edge portions 168D. Each portion 168D can be seen separated by portion 168C. Portion 168C may be substantially planar but insert 160 is not so limited any manner or shape may be used to separate portion 168C. Similarly, groove 168B may be circular as depicted by may also be rectangular, elliptical or otherwise curved, or otherwise shaped as need or desired to retain byproduct and induce flow towards portion 169 as described. As can also be seen, one or more member 165 may be disposed between corresponding channels 168 as needed or desired.

Whether in use with insert 160 or not, the herein disclosed device 110 is particularly advantageous since it provides an environment in which a food article may be positioned as desired (e.g. flat or wrapped up) and byproducts such as fat or juices may be uniformly drawn from multiple sides of said food article and caused to flow down a predetermined angled surface towards receptacle 119. Further, the amount of pressure and/or heat applied to each side of the food article can be adjusted with the herein disclosed novel adjustment mechanisms 125 between areas 111 and corresponding lids 113.

Turning to FIG. 22, another exemplary insert 160′ can be seen similar to insert 160. As can be seen, insert 160′ may comprise channels 168′ with portion 169′ operable to urge fluids from channels 168′ and preferably towards an associated byproduct receptacle, for example, of base 105 and/or surface 111. As can be seen, insert 160′ may also comprise its own receptacle portion 169″ opposite portion 169′. Portion 169″ may also receive fluids and other byproducts produced by a particular food article during cooking when positioned in channels 168′.

It also to be understood that channels 168 and/or 168′ may include one or more shapes or designs so that when a food article is detachably positioned therein, during cooking the food article is urged to form the associated shape of the channel 168/168′. In certain embodiments, insert 160 and 160′ may be constructed from flexible material such as silicone. In this embodiment, channels 168/168′ are operable to apply inward pressure on the food article positioned therein. In this respect, a food article such as rolled up bacon may be loaded in respective channels 168/168′ in the tray 168A to prevent the food article from being displaced during cooking. For example, if the food article is bacon, channels 168/168′ are operable to prevent the bacon from unrolling during use. FIGS. 1-21 depict specific implementations of the herein disclosed solution. However, the embodiments of FIGS. 1-21 are not so limited and many alterations and modifications may be made by those having ordinary skill in the art without departing from the spirit and scope of the embodiments disclosed and described herein. Therefore, it is understood that the illustrated and described embodiments have been set forth only for the purposes of examples and that they are not to be taken as limiting the embodiments as defined by the following claims. For example, notwithstanding the fact that the elements of a claim are set forth below in a certain combination, it must be expressly understood that the embodiments include other combinations of fewer, more or different elements, which are disclosed above even when not initially claimed in such combinations.

The definitions of the words or elements of the following claims are, therefore, defined in this specification to not only include the combination of elements which are literally set forth. It is also contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination(s).

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what incorporates the essential idea of the embodiments.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device for cooking one or more food articles, the device comprising:
a base defined by one or more perimetral edges;
a cooking surface received by the base between the edges; and
a lid received by the cooking surface opposite the base.

2. The device according to claim 1, further comprising a plurality of clamps disposed on the one or more perimetral edges of the base, the clamps operable to securely engage the cooking surface.

3. The device according to claim 2, further comprising a crossbar in communication with each of the clamps, the clamps being disposed on opposite edges of the base.

4. The device according to claim 3, wherein the crossbar is operable to receive downward pressure causing the clamps to flex outwardly and inwardly retract to secure the lid to the base.

5. The device according to claim 4, the crossbar being integrally formed or detachable with the cooking surface and the cooking surface being formed from heat resistant and flexible material.

6. The device according to claim 1, wherein the lid is removably and/or pivotally connected to an edge of the base.

7. The device according to claim 1, wherein the lid is operable to apply downward pressure to the one or more food articles positioned on the cooking surface.

8. The device according to claim 7, further comprising a pressure adjustment mechanism in communication with one or more handling surfaces of the lid.

9. The device according to claim 8, wherein the pressure adjustment mechanism is rotably adjusted to increase or decrease pressure applied to the cooking surface.

10. The device according to claim 9, wherein the pressure adjustment mechanism further comprises one or more spring bias or resistance elements in communication with the one or more handling surfaces.

11. The device according to claim 1, wherein the lid further comprises one or more handling surfaces formed by one or more rods, sticks, forks, knobs, or tubes, wherein the handling surface is operable to secure or manipulate the one or more food articles positioned on the cooking surface.

12. The device according to claim 11, wherein the handling surface is operable to suspend, elevate or otherwise hang the one or more food articles removable positioned inside the device.

13. The device according to claim 9, the device being connected to or in communication with a heating supply, the base further comprising one or more chambers or angled portions to receive contents discarded by the one or more food articles during cooking.

14. The device according to claim 7, wherein the lid further comprises an externally visible food cooking monitor wherein the monitor includes a temperature gauge, a timer, or one or more transparent portions of the lid providing externally visible excess to the one or more food articles inside the device.

15. The device according to claim 1, further comprising:
a tray insert removably connected to the base and the cooking surface, the tray insert comprising a plurality of food article receiving channels disposed between peripheral edges dimensioned to be positioned within the base, each channel comprising a predetermined shape for forming the one or more food articles into the predetermined shape during use.

16. The device according to claim 15, the tray insert further comprising a sloped central support member disposed between the peripheral edges of the tray insert, the sloped central support member being operable to direct fluid byproducts of the one or more food articles into a receiving channel of the tray insert.

17. The device according to claim 15, the predetermined shape being formed by one or more of the food article receiving channels that are C-shaped, U-shaped, rectangular, angled, rounded, elliptical, or polygonal.

18. The device according to claim 15, wherein the tray insert is flexible so that pressure from one or more directions can be applied to the one or more food articles thereby securing and maintaining the one or more food articles in the predetermined shape during cooking.

19. A method of using a device for cooking one or more food articles, the device comprising:
a base defined by one or more perimetral edges;
a cooking surface received by the base between the edges; and
a lid received by the cooking surface opposite the base, the lid being pivotally connected to an edge of the base and operable to apply downward pressure to the one or more food contents positioned on the cooking surface; and
a pressure adjustment mechanism in communication with one or more handling surfaces of the lid,
the method comprising the following steps:
removably placing the one or more food articles on the cooking surface in a predetermined arrangement;
pivotably positioning the lid into a predetermined position relative to the one or more food articles and the cooking surface;
rotably adjusting an amount of pressure applied to the cooking surface; and
introducing heat to the one or more food articles in the predetermined position on the cooking surface.

20. A system of using
a device for cooking one or more food articles, the device comprising:
a base defined by one or more perimetral edges;
a cooking surface received by the base between the edges; and
a lid received by the cooking surface opposite the base, the lid being pivotally connected to an edge of the base and operable to apply downward pressure to the one or more food contents positioned on the cooking surface; and
a pressure adjustment mechanism in communication with one or more handling surfaces of the lid,
the method comprising the following steps:
removably placing the one or more food articles on the cooking surface in a predetermined arrangement;
pivotably positioning the lid into a predetermined position relative to the one or more food articles and the cooking surface;
rotably adjusting an amount of pressure applied to the cooking surface; and
introducing heat to the one or more food articles in the predetermined position on the cooking surface, the one or more food articles being bacon.
